(19) United States
(12) Patent Application Publication
(10) Pub. No.: US 2017/0329364 A1
(43) Pub. Date: Nov. 16, 2017

(54) DISPLAY DEVICE

(71) Applicant: LG ELECTRONICS INC., Seoul (KR)

(72) Inventors: Hohyung KIM, Seoul (KR); Hoeyoon KIM, Seoul (KR)

(73) Assignee: LG ELECTRONICS INC., Seoul (KR)

(21) Appl. No.: 15/531,231

(22) PCT Filed: Dec. 1, 2014
(86) PCT No.: PCT/KR2014/011649

§ 371 Date: May 26, 2017

(30) Foreign Application Priority Data
Nov. 27, 2014 (KR) 10-2014-0167202
Nov. 27, 2014 (KR) 10-2014-0167228

(51) Int. Cl. G06F 1/16; H04N 5/74; G06F 1/20

(52) U.S. Cl. CPC G06F 1/1601; H04N 5/74; G06F 1/1643; G06F 1/20; G06F 2200/1631

(57) ABSTRACT

The display device according to an embodiment of the present invention includes comprises a display module configured to display an image; a stand configured to support the display module; and a PC unit configured to be mounted inside the stand and electrically connected to the display module, wherein the stand completely covers the hinge unit in a rear of the display module.

### TECHNICAL FIELD

The present invention relates to a display device, and more specifically to an all-in-one computer.

### BACKGROUND ART

Display device is a device to display a visual image, which generally refers to a device having a display panel, such as a television set and a monitor. Recently, PC market reflects a slimness trend so that an all-in-one PC is highlighted as a display device.

A conventional display device as an all-in-one PC is disclosed in Korean Patent Laid-Open Publication No. 10-2011-0025540. The display device disclosed in the publication includes a display module to display images and a stand to support the display module. The stand has a PC unit embedded therein and is seated on the ground so as to support the display module. The conventional display device has a PC unit embedded therein in the horizontal direction of the stand which is supported on the ground.

However, the conventional display device requires a significant volume when packing products since the stand occupies a large width in the back and forth direction due to such a disposition of the PC unit. Such a display module and a stand are combined to form a finished product in the conventional display device, so that there is a problem that it is inevitable to enlarge volume due to the product packing.

The above-described problem acts as an obstruction factor to the recent slimness trend, so that a scheme is required that is capable of providing a slimness display device which improves a user's convenience.

### INVENTION

### Technical Problem

Accordingly, it is the objective of the present invention to provide a display device which is slimmer for a user's convenience.

### Technical Solution

In order to solve the problem, there is provided a display device, which comprises a display module configured to display an image; a stand configured to support the display module; and a PC unit configured to be embedded in the stand and electrically connected to the display module, wherein the stand includes: a stand body which is mounted in a rear of the display module and has the PC unit embedded therein; and a stand base which is connected to the stand body.

Preferably, the display device may further comprise at least one antenna module which is embedded in the stand body in order to communicate with an external device.

Preferably, the PC unit may include a PC board configured to be disposed in the rear of the display module and electrically connected to the display module through a cable; and a cooling fan configured to be disposed separately from the PC in a predetermined distance.

Preferably, the stand body may include a front cover configured to be disposed in the rear of the display module; a body base configured to be disposed in a rear of the front cover and in which the PC board and the cooling fan are installed; and a rear cover configured to cover the body base in a rear of the body base.

Preferably, the front cover may have a fan outlet formed in the direction facing the rear surface of the display module.

Preferably, the cooling fan may be disposed to face the fan outlet.

Preferably, the at least one antenna module may be disposed between the display module and the stand base.

Preferably, the antenna module may be provided in plurality.

Preferably, the plurality of antenna modules may include a main antenna module configured to be disposed at a position under the stand body; and an auxiliary antenna module configured to be disposed apart from the main antenna module in a predetermined distance.

Preferably, the main antenna module may include a Wi-Fi module and the auxiliary antenna module may include a Bluetooth module.

Preferably, the stand base may be detachably connected to the stand body.

Preferably, the display device may further comprise a hinge unit configured to connect the display module and the stand each other and to control an angle of the display module, wherein the stand completely may cover the hinge unit in the rear of the display module.

Preferably, the hinge unit may include a first hinge frame configured to be installed in the rear of the display module; a second hinge frame configured to be hingedly connected to the first hinge frame and to be installed inside the stand; and at least one hinge shaft configured to pass through the first and second hinge frames.

Preferably, the hinge shaft may be provided in a pair, and wherein the hinge unit may further include an elastic member mounted in any one hinge shaft of the pair of hinge shafts.

Preferably, the second hinge frame may include a base portion configured to be extended in a horizontal direction of the stand; at least one shaft mounting portion configured to be bent from an end of the base portion and in which the at least one hinge shaft is installed; and a support configured to be extended downwards from the base portion and to be supported to the stand.

Preferably, the hinge shaft may be provided in a pair, wherein the shaft mounting portion may include a first mounting portion configured to be bent upwards from one end of the base portion; and a second mounting portion configured to be bent upwards from the other end of the base portion.

Preferably, the PC unit may be connected to the display module through a cable, wherein the cable may be connected to the display module by passing through the first hinge frame at an upper side of the base portion.

Preferably, the stand may include a stand body configured to be installed in the rear of the display module and to have the PC unit embedded therein; and a stand base configured to be connected to the stand body, and wherein the second hinge frame and the at least one hinge shaft may be embedded in the stand body.

Preferably, the stand body may include a front cover configured to be disposed in the rear of the display module; a body base configured to be disposed in the rear of the front cover and to have the PC unit mounted therein; and a rear cover configured to cover the body base in the rear of the body base, wherein the second hinge frame may be mounted in the body base, and wherein the rear cover may completely cover the hinge unit.

Preferably, the display device may be an all-in-one computer.

### Advantageous Effects

According to the various embodiments described above, a slimmer display device may be provided which improves a user's convenience.

### DESCRIPTION OF DRAWINGS

FIG. 1 is a perspective view illustrating a display device according to an embodiment of the present invention.

FIG. 2 is a rear perspective view illustrating the display device in FIG. 1.

FIG. 3 is a broken perspective view illustrating the display device in FIG. 1.

FIG. 4 is a perspective view illustrating a display module of the display device in FIG. 1.

FIG. 5 is a perspective view illustrating a hinge unit mounted in the display module in FIG. 4.

FIG. 6 is a broken perspective view illustrating a hinge unit in FIG. 5.

FIG. 7 is a broken perspective view illustrating a stand body in a stand of the display device in FIG. 3.

FIGS. 8 to 10 are views describing how to assemble a display module and a stand of the display device in FIG. 2.

FIG. 11 is a schematic front view illustrating the display device in FIG. 1.

### BEST MODE

Hereinafter, preferred embodiments of the present invention will be described in more detail with reference to the accompanying drawings. Here, it is noted that the embodiments described here are exemplary ones suggested for easy understanding of the invention, and the present invention may be embodied in various modifications differently from the embodiments described here. Further, for easy understanding of the invention, attached drawings may not be illustrated in actual scales but be exaggerated in dimensions of some elements.

A display device is a device which includes a display element used to display image and display visual image. It may be various devices to display images, such as television set, monitor, all-in-one PC, laptop PC, tablet PC, smart phone, personal digital assistant, electronic book reader, electronic picture frame and KIOSK. Hereinafter, a display device of the present embodiment is described limited to an all-in-one PC.

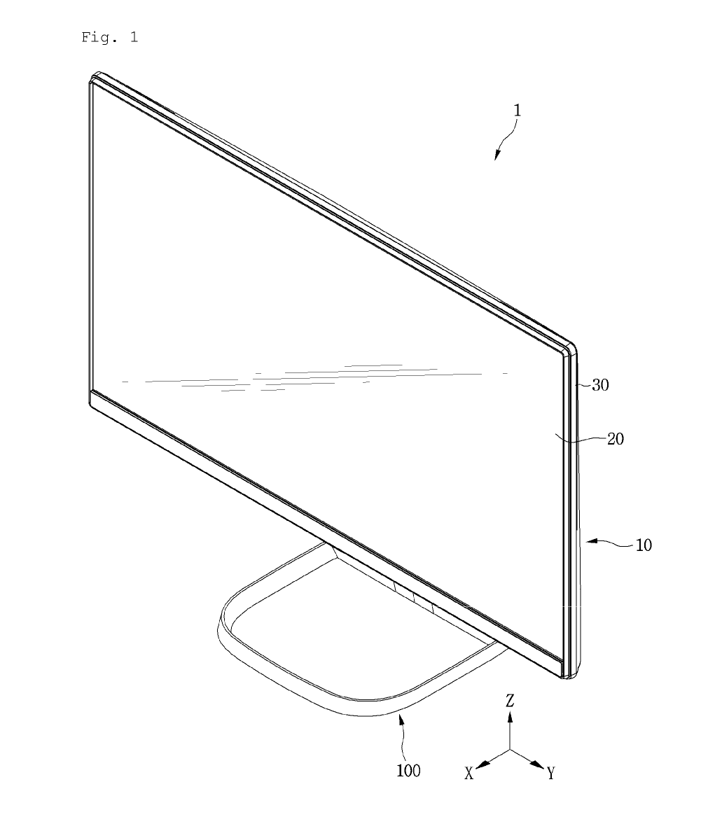

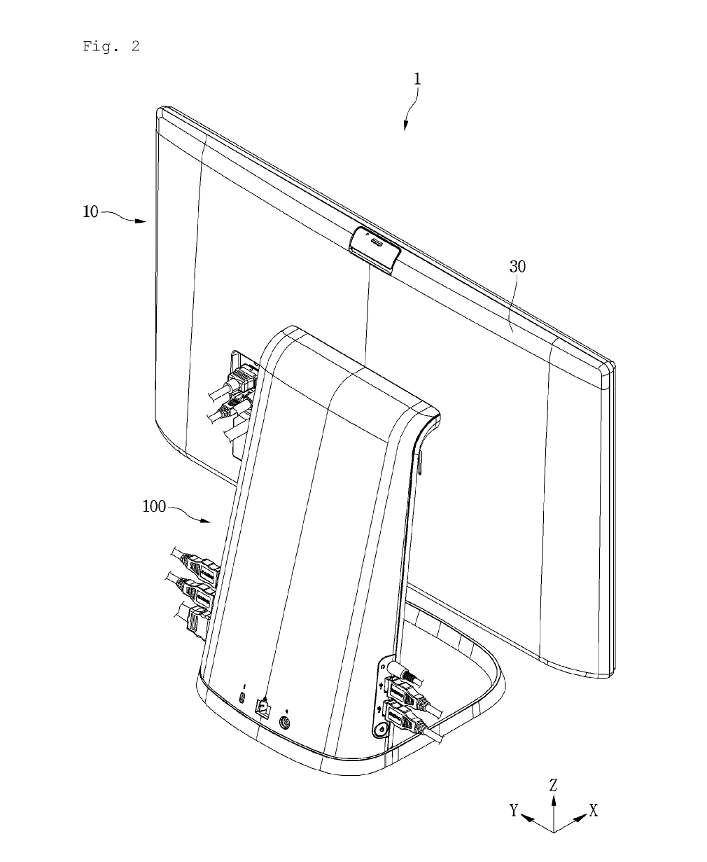

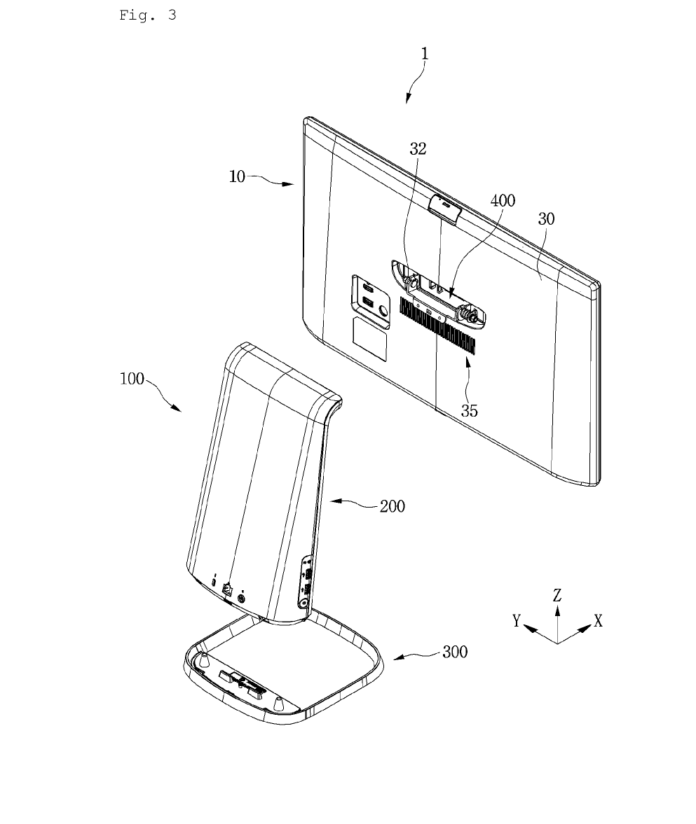

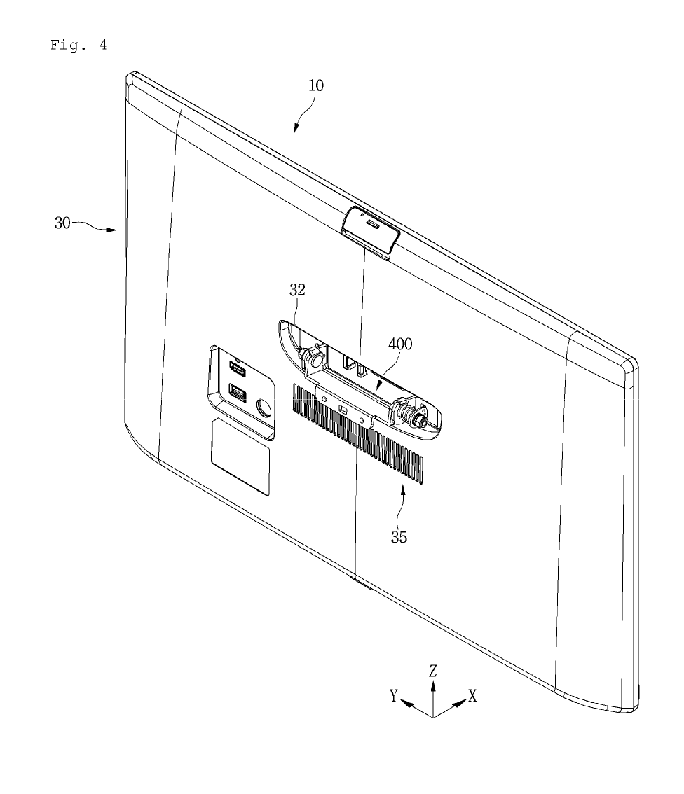

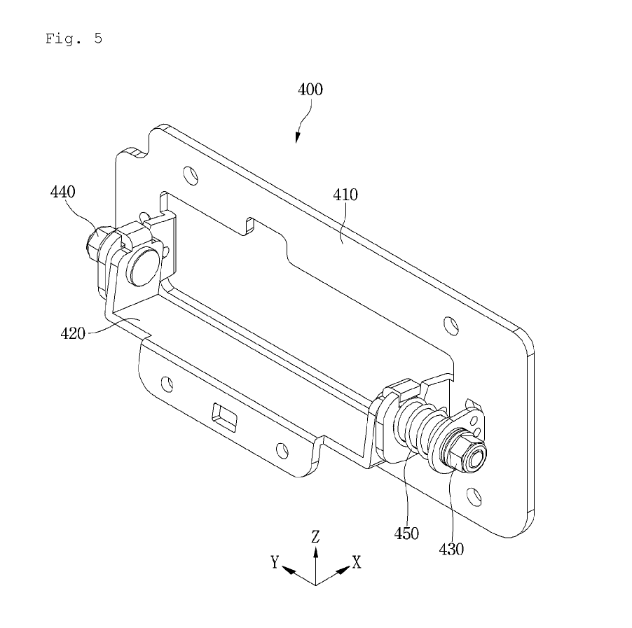

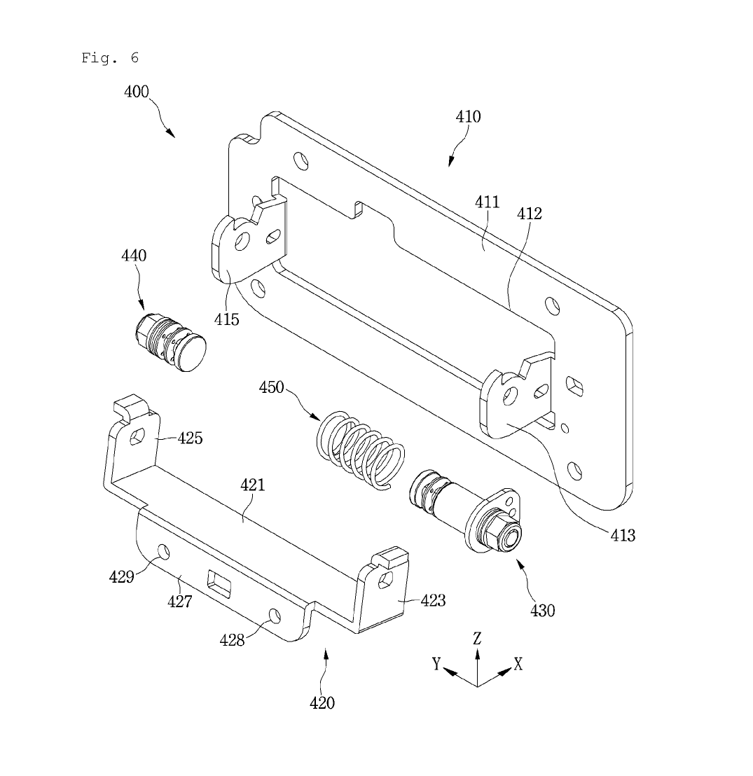

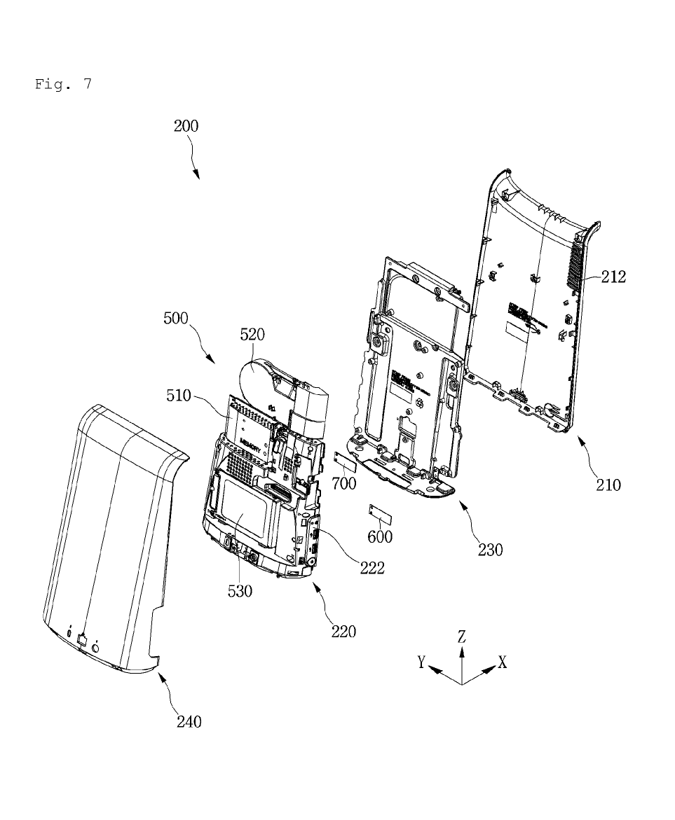

FIG. 1 is a perspective view illustrating a display device according to an embodiment of the present invention, FIG. 2 is a rear perspective view illustrating the display device in FIG. 1, FIG. 3 is a broken perspective view illustrating the display device in FIG. 1, FIG. 4 is a perspective view illustrating a display module of the display device in FIG. 1, FIG. 5 is a perspective view illustrating a hinge unit mounted in the display module in FIG. 4, FIG. 6 is a broken perspective view illustrating a hinge unit in FIG. 5, FIG. 7 is a broken perspective view illustrating a stand body in a stand of the display device in FIG. 3.

Referring to FIGS. 1 to 7, a display device 1 includes a display module 10, a stand 100, a hinge unit 200, a PC unit 500 and antenna modules 600 and 700.

The display module 10 is a component to provide a user or the like with image and sound. For this, the display module 10 has kinds of parts to provide such image and sound therein.

Such a display module 10 includes a display 20 and a display cover 30.

The display 20 is used to display image outwards, which may be configured of various displays to display image. The display 20 is a flat display, which may be configured of any one of a plasma display panel module, a liquid crystal display module, a light emitting diode module and an organic light emitting diode. For example, when the display 20 is a liquid display, the display module 10 may include a liquid panel to display image and a backlight unit to provide the liquid panel with light. Further, the display 20 may be configured of a curved display other than a flat display or a flexible display. Furthermore, the display 10 may be configured of a touch type display, too.

The display cover 30 is a component to cover the display 20. Such a display cover 30 may be configured of a single cover or a plurality of covers. When it is configured of a plurality of covers, the display cover 30 may be configured of a decoration cabinet, a cover bottom and a back-cover.

The display cover 30 has a stand mounting hole 32 to mount a stand to be described therein formed in its rear surface. Further, the display cover 30 has a variety of interface cables such as a power cable to supply the display module 10 with power and a cable to supply sound, mounted in its rear surface.

Further, the display cover 30 has a heat sink 35 to cool the display module 10, which is arranged under the stand mounting hole 32 in the rear of the display cover. Such a heat sink 35 is formed in front of the stand body 200 of the stand 100. Accordingly, the heat sink 35 may be disposed not to be exposed to the outside of the display device 1.

The stand 100 is a component to support the display module 10. The stand 100 is mounted in the rear of the display module and seated on the ground or the like to stably support the display module 10. Here, the stand 100 is mounted in the rear of the display module 10 so as to completely cover a hinge unit 400 to be described.

The stand 100 has a PC unit 500 connected electrically to a display module 10 to be described, which is mounted therein. Therefore, the display device 1 may operate as an all-in-one PC.

Such a stand 100 includes a stand body 200 and a stand base 300.

The stand body 200 is mounted in the rear of the display module 10, and disposed nearly in the height direction of the display module 10 and in the lower direction of the display module 10. Further, the stand body 200 has a PC unit 500 connected electrically to the display module 10, which is embedded therein.

Such a stand body 200 includes a front cover 210, body bases 220 and 230 and a rear cover 240.

The front cover 210 is disposed in the rear of the display module 10. When the display module is mounted, such a front cover 210 is partially exposed to the lower portion of the display module in front of the display device 1.

The front cover 210 has a fan outlet 212 formed in the upper portion of the front cover 210. Such a fan outlet 212 is formed opposite to the rear surface of the display cover 30 of the display module 10. Accordingly, the fan outlet 212 may be disposed not to be exposed to the outside of the display device 1.

The body bases 220 and 230 are components to mount a stand base 300, a PC unit 500 and antenna modules 600 and 700 therein, which are described below. Such body bases 220 and 230 may be configured in plural number or a single frame. Hereinafter, the present embodiment describes that the body bases 220 and 230 are restricted to a pair.

Such a pair of body bases 220 and 230 includes a first base 220 and a second base 230.

The first base 220 has a PC unit 500 mounted therein, which is described below. Further, the first base 220 has an interface 222 on its both sides, which is electrically connected to the PC unit 500 and used to mount various interface cables related with the PC unit therein.

In the present embodiment, the interface 222 is included on both sides of the first base 220 and interface cables or the like are mounted on both sides of the stand 100, so that a space occupied by mounting the interface cable or the like in the back and forth direction of the display device 1 may be reduced.

Meanwhile, the interface 222 has an interface for USB 3.0 port which is arranged apart from the main antenna module 600 to be described in order to prevent an interference with the main antenna module 600. It is because the USB 3.0 cable acts as an element to hinder emission of a Wi-Fi module.

The second base 230 is coupled to the front cover 210 and disposed between the front cover 210 and the first base 220. Such a second base 230 has a first base 220 seated therein. Further, the second base 230 is detachably coupled to the stand base 300.

The rear cover 240 is disposed in the rear of the display module 10, and is coupled to the front cover 210 while completely covering the body bases 220 and 230 in the rear of the first base 220. Accordingly, the rear cover 240 is coupled to the front cover 210 in order to completely cover a hinge unit 400 to be described.

The stand base 300 is connected to the stand body 200, specifically to the second base 230 to be seated on the ground. Here, the stand base 300 is detachably connected to the stand body, specifically to the second base 230. Accordingly, in the present embodiment, the stand base 300 may be separated from the stand body 200 when shipping the product, to be transferred to the user.

such a stand base 300 may be formed of a metal material. That considers design and stiffness. That is, the metal material of the stand base 300 makes the appearance design of the display device 1 magnificent and obtains a support stiffness.

Such a hinge unit 400 includes a first hinge frame 410, a second hinge frame 420, hinge shafts 430 and 440 and an elastic member 450.

The first hinge frame 410 is disposed approximately parallel to the display module 10 in the rear of the display module 10, and mounted in the rear of the display module 10. Specifically, the first hinge frame 410 passes through a stand mounting hole 32 of the display cover 10 to be mounted inside the display module 10.

Such a first hinge frame 410 includes a first hinge base 411 and hinge protrusion portions 413 and 415.

The first hinge base 411 is disposed parallel to the display module 10, disposed inside the stand mounting hole 32 and mounted inside the display module 10. Such a first hinge base 411 has a cable through hole 412 therein which is used to pass through a cable C to be described.

The pair of hinge protrusion portions 413 and 415 each protrudes toward the rear portion of the display module 10 in both ends of the cable through hole 412. Such a pair of hinge protrusion portions 413 and 415 includes a first protrusion portion 413 and a second protrusion portion. The first protrusion portion 413 and the second protrusion portion 415 have hinge shafts 430 and 440 to be described, respectively, which are mounted therein. Meanwhile, when the hinge protrusion portion may be moved to control an angle of the display module 10, they may be designed and integrated in one device.

The second hinge frame 420 is hingedly connected to the first hinge frame 410, and mounted inside the stand 100. Specifically, the second hinge frame 420 is mounted in the body base 230 of the stand body 200 in the stand body 200 by a screw coupling. That is, the second hinge frame 420 is screw-coupled to the second base 230 of the stand body 200.

Such a second hinge frame 420 includes a base portion 421, a pair of shaft mounting portions 423 and 425 and a support 427.

The base portion 421 extends in the horizontal direction of the stand 100, which is formed approximately in a plate shape. The base portion 421 is formed in a plate shape, wherein its upper portion is exposed so that a workability may be improved when the cable C of the PC unit 500 to be described is connected to the display module 10. Specifically, the cable C may pass through the cable through hole 412 of the first hinge frame 410 over the base portion 412 so as to be electrically connected to a control board (not shown) inside the display module 10.

A pair of shaft mounting portions 423 and 425 each is bendably formed upwards from both ends of the base portion 421. Such a pair of shaft mounting portions 423 and 425 includes a first mounting portion 423 which is bendably formed upwards from one end of the base portion 421 and a second mounting portion 425 which is bendably formed upwards from the other end of the base portion 421. The first mounting portion 423 and the second mounting portion 425 have a hinge shafts 430 and 440 to be described, respectively, which are mounted therein.

The support 427 extends downwards from the rear end of the base portion 420, and is mounted in the stand to be supported to the stand 100. Specifically, the support 427 is screw-coupled to the second base 230 of the stand body 200. To do this, the support 427 has a pair of screw fasting holes 428 and 429 fastened to a screw member S, which is formed therein. Meanwhile, the number of the screw fastening holes may also be changed suitably depending on designs.

The hinge shafts 430 and 440 are embedded in the stand body 200 and pass through the first hinge frame 410 and the second hinge frame 420 so as to control angle of the display module 10. The display module 10 may move upwards and downwards with respect to the stand 100 through the hinge shafts 430 and 440.

The hinge shafts 430 and 440 may be configured in pair. The number of the hinge shaft may be one when it can be hingedly connected to the display module 10 so as to be moved upwards and downwards. Hereinafter, it is described that the present embodiment is restrictively configured in a pair of hinge shafts 430 and 440.

The pair of hinge shafts 430 and 440 is configured of a first hinge shaft 430 and a second hinge shaft 440.

The first hinge shaft 430 is configured of a plurality of components for a hinge connection, which is shaft coupled to a first protrusion portion 413 of the first hinge base 410 and a first mounting portion 423 of the second hinge base 420.

The second hinge shaft 440 is configured of a plurality of components for a hinge connection like the first hinge shaft 430, which is shaft coupled to a second protrusion portion 415 of the first hinge base 410 and a second mounting portion 425 of the second hinge base 420.

The elastic member 450 is a component to provide an elastic force when it is hingedly connected to move the display module 10. To do this, the elastic member 450 may be configured of a coil spring to provide an elastic force. Such elastic member 450 may be configured of one or more. Hereinafter, the present embodiment describes that the elastic member 450 is limitedly configured of one.

The elastic member 450 is mounted in the first hinge shaft 430 to provide an elastic force when being moved hingedly. Otherwise, the elastic member 430 may be mounted in the second hinge shaft 440, too. Further, as described above, the elastic member 450 may be mounted in both the first hinge shaft 430 and the second hinge shaft 440.

The PC unit 500 is embedded in the stand 100, and electrically connected to the display module 100. The display device 1 may operate as an all-in-one PC when it is electrically connected to the PC unit 500.

Such a PC unit 500 includes a PC board 510, a cooling fan 520 and a hard disk 530.

The PC board 510 is disposed in the rear of the display module 10, and electrically connected to the display module 10 through a cable C to be described. Such a PC board 510 is mounted in the first base 220 of the stand body 200 and disposed between a cooling fan 520 and a hard disk 530, which is described below.

The cooling fan 520 is a component to cool the heat occurred when driving the PC unit. The cooling fan 520 is embedded in the stand body 200. Specifically, the cooling fan 520 is mounted in the first base 220 of the stand body 200, and is disposed over the PC board 510 apart from the PC board 510 by a predetermined distance. Here, the cooling fan 520 is disposed to face the fan outlet 212 of the first base 220 in order to discharge or inhale air. Since the cooling fan 520 is well known, its detailed description is omitted.

The hard disk 530 is a component to store or record a variety of programs of the PC unit 500. The hard disk 530 is embedded in the stand body 200 of the stand 100. The hard disk 530 is mounted in the first base 220 of the sand body 200, which is disposed under the PC board 510 apart from the PC board 510 by a predetermined distance. Since the hard disk 530 is well known, its detailed description is omitted.

The antenna modules 600 and 700 are components with which the display device 1 and external equipment wirelessly communicate each other. The antenna modules 600 and 700 may be configured of a chip type antenna module. The chip type antenna module has an advantage that it minimizes an antenna signal interference with conductive materials, compared to a general PIFA type antenna module. Accordingly, the antenna modules 600 and 700 according to the present embodiment may minimize the antenna signal interference from the frame of surrounding conductive material or the like.

Such antenna modules 600 and 700 are configured of one or more. Hereinafter, it is descried that the present embodiment is limited to a pair of antenna modules 600 and 700.

The pair of antenna modules 600 and 700 is electrically connected to the PC unit 500, and embedded in the stand 100. More specifically, the pair of antenna modules 600 and 700 is embedded in the stand body 200 of the stand 100. According to such a disposition, the pair of the antenna modules 600 and 700 is disposed between the display module 10 and the stand base 300.

The pair of antenna modules 600 and 700 includes a main antenna module 600 and an auxiliary antenna module 700.

The main antenna module 600 is disposed at a side under the sand body 200. Specifically, the main antenna module 600 is mounted at a side under the first base 220 of the stand body 200. Such a main antenna module 600 may be a Wi-Fi module. The main antenna module 600 is not limited thereto but may be configured of other modules which is capable of wirelessly communicating with external equipment. For example, the main antenna module 600 may be configured of radio communication antenna module which performs communications according to a variety of communication standards, such as Bluetooth module, NFC scheme antenna module or IEEE, ZigBee, 3G (3^{rd} Generation), 3GPP (3^{rd} Generation Partnership Project) and LTE (Long Term Evolution).

The auxiliary antenna module 700 is disposed apart from the main antenna module 700 by a determined distance. Specifically, the auxiliary antenna module 700 is upwardly detached from the main antenna module 700, and is mounted in the lower center portion of the first base 220 of the stand body 200. Such an auxiliary antenna module 700 may be a Bluetooth module. The auxiliary is not limited thereto but configured of other modules which is capable of wirelessly communicating with external equipment. For example, the auxiliary antenna module 700 may be configured of radio communication antenna module which performs communications according to a variety of communication standards, such as Wi-Fi module, NFC scheme antenna module or IEEE, ZigBee, 3G (3^{rd} Generation), 3GPP (3^{rd} Generation Partnership Project) and LTE (Long Term Evolution).

Hereinafter, an assembly process of the display device 1 according to the present embodiment is described in detail.

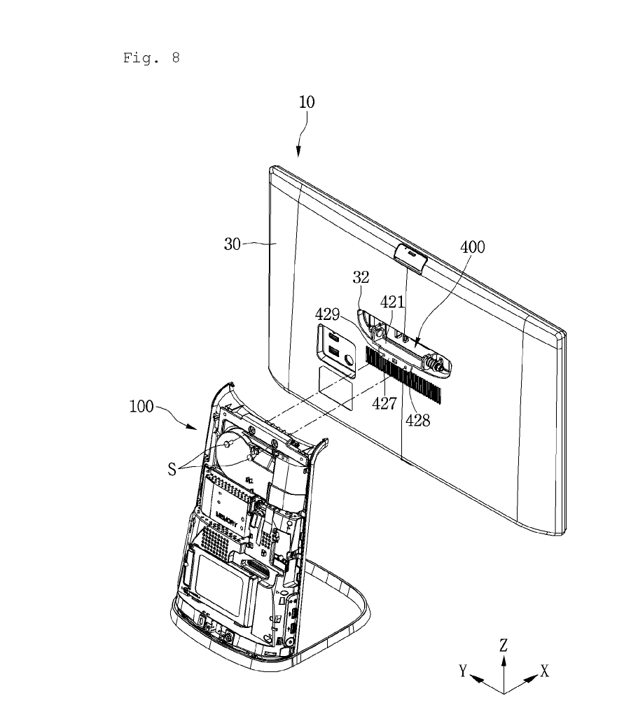

FIGS. 8 to 10 are views describing how to assemble a display module and a stand of the display device in FIG. 2.

Referring to FIG. 8, a stand 100 has a PC unit 500 (referring to FIG. 7) mounted therein in the state that its rear cover 240, referring to FIG. 7) is removed, and is mounted in the rear of the display module 10. A manufacturer or the like inserts the upper portion of the stand 100 into a stand hole 32 of the display cover 30 and then screw couples the stand 100 and a second hinge frame 420 of the hinge unit 400 mounted inside the display module each other. Specifically, a pair of screw member S passes through the stand 100 and a pair of screw clamping holes 428 and 429 included in the support 427 of the second hinge frame 420 to screw couple them.

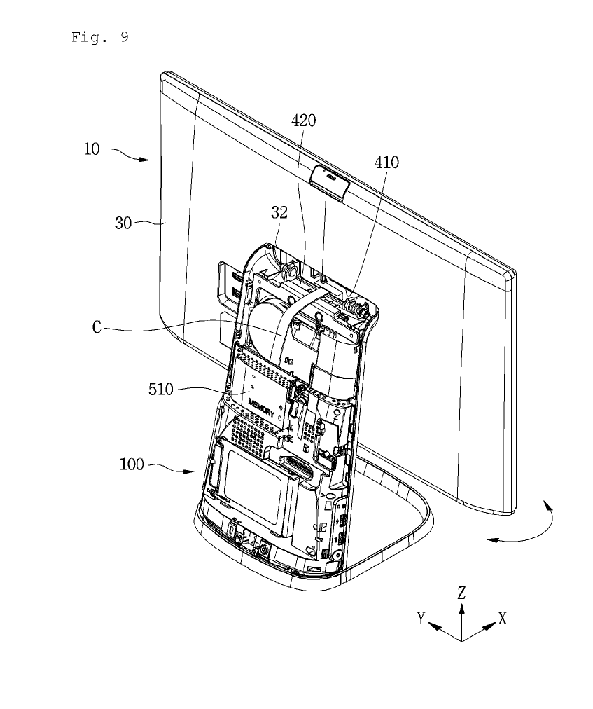

Referring to FIG. 9, hereinafter, a manufacturer or the like connects a cable C which is used to electrically connect the PC unit 500 (referring to FIG. 7) and the display module each other into the display module 10.

The cable C passes through the screw mounting hole 32 and the cable through hole 412 (referring to FIG. 5) of the first hinge frame 410 over the second hinge frame 420 to be mounted inside the display module 10. Here, since the second hinge frame 420 has a structure in which its upper portion is exposed, a manufacturer or the like may obtain an open working space when mounting the cable C so that workability reduction due to the structure may be remarkably improved.

Further, according to the present embodiment, the PC unit 500 is embedded in the stand body 200 of the stand 100 (referring to FIG. 3), the distance between the PC board 510 of the PC unit 500 and the display module 10 becomes remarkably short, compared to the case that the stand base 300 (referring to FIG. 3) includes the PC unit 500.

Accordingly, since the present embodiment can also make the cable C which electrically connects the PC board 510 and the display module 10 short, a manufacturing coat for the cable C can be reduced, too.

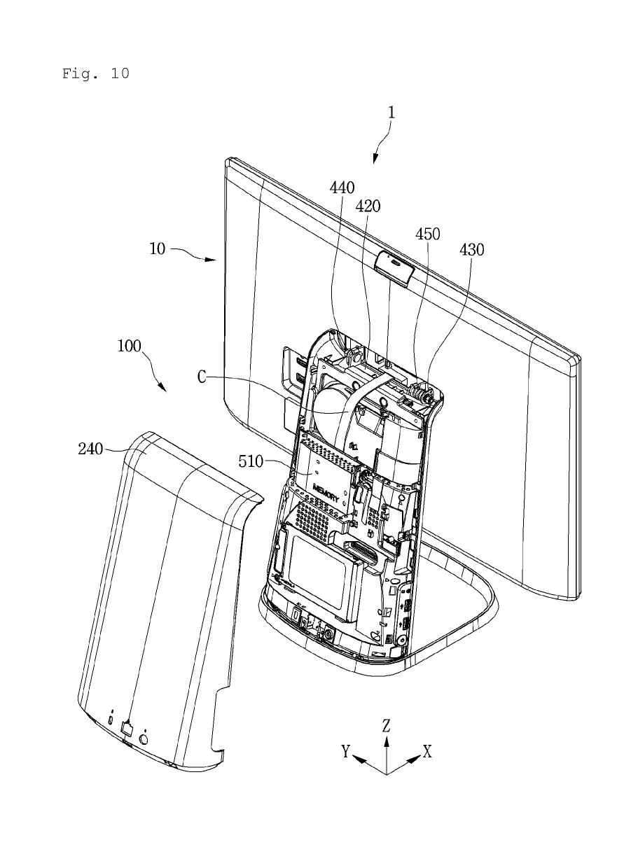

Referring to FIG. 10, finally, a manufacturer or the like couple the rear cover 240 of the stand 100 in order to completely cover the hinge unit 400 (referring to FIG. 3) and the PC unit 500 (referring to FIG. 7) not to be exposed outside. Specifically, the rear cover 240 of the stand 100 covers all of the second hinge frame 420 of the hinge unit 400, the first hinge shaft 430, the second hinge shaft 440 and the elastic member 450 not to be exposed outside the display device 1.

Through such an assembly process, the display device 1 according to the present embodiment can remarkably improve the process efficiency to assemble the display device 1 and the display module 10.

Further, a manufacturer or the like may separate and pack the stand base 300 of the stand 100, when packing the products. Accordingly, the present embodiment may reduce the volume to pack the product which is needed due to the width of the stand base 300 in the back and forth direction when packing the product.

Accordingly, in the present embodiment, a user or the like may be provided with a product packed in a slimmer shape and a finished product of the display device 1 may be embodied by coupling the stand base 300 to the stand body 200 with a simple operation by a user in home or a company.

Hereinafter, a wave radiation and other characteristics of the display device 1 according to the present embodiment will be considered.

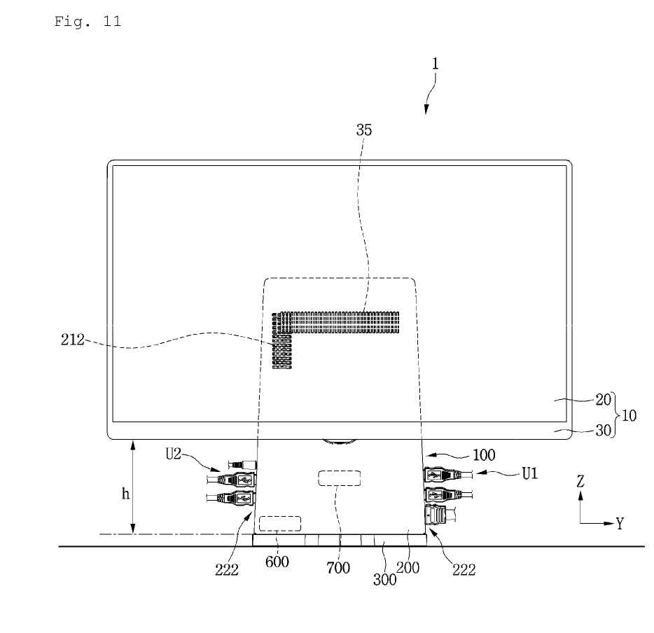

FIG. 11 is a schematic front view illustrating the display device in FIG. 1.

Referring to FIG. 11, first, since the main antenna module 600 and the auxiliary antenna module 700 are disposed between the display module 10 and the stand base 300, it may smoothly emit an electric wave in the front direction of the display device 1.

Further, the main antenna module 600 is disposed at a side under the stand body 200, in order to prevent the main antenna module 600 to be interfered with a USB 3.0 cable U1 between a variety of cables U1 and U2 mounted at any one side of interfaces 222 of both sides of the stand body 200. The USB 3.0 cable U1 may operate as a factor to obstruct an electric wave radiation efficiency of an antenna, as described above. In order to prevent it, the present embodiment is designed that the main antenna module 600 is disposed opposite to the USB 3.0 cable U1 as described above.

Further, since the heat sink 35 of the display module 10 and the fan outlet 212 of the stand 100 are disposed not to be exposed to the outside of the display device 1 in the present embodiment, the appearance of the display device 1 may be improved in the viewpoint of design.

As such, in the present embodiment, since the PC unit 500 (referring to FIG. 7) and the antenna modules 600 and 700 (referring to FIG. 7) are disposed not in the stand base 300 but in the stand body 200, the volume of the stand base 300 may be remarkably reduced, so that a space to occupy the stand base 300 in the back and forth direction may be reduced.

Accordingly, the display device 1 according to the present embodiment may realize the display device 1 that is slimmer according to the recent slimness trend and has an improved appearance.

As a result, the display device 1 according to the present embodiment may provide a slimmer display device 1 with an improved user's convenience.

Hereinbefore, while the preferred embodiments of the present invention have been illustrated and described, the present invention is not restricted to specific embodiments described above. Also, it is obvious to those skilled in the art that other various modifications based on the technical ideas of the present invention may be embodied without departing from the gist of the present invention claimed in the claims and such modified embodiments may not be understood separately from technical ideas and prospects of the present invention.

1. A display device, comprising:
a display module configured to display an image;
a stand configured to support the display module; and
a PC unit configured to be embedded in the stand and electrically connected to the display module,
wherein the stand includes:
a stand body which is mounted in a rear of the display module and has the PC unit embedded therein; and
a stand base which is connected to the stand body.

2. The display device of claim 1, further comprising at least one antenna module which is embedded in the stand body in order to communicate with an external device.

3. The display device of claim 1, wherein the PC unit includes:
a PC board configured to be disposed in the rear of the display module and electrically connected to the display module through a cable; and
a cooling fan configured to be disposed separately from the PC in a predetermined distance.

4. The display device of claim 3, wherein the stand body includes:
a front cover configured to be disposed in the rear of the display module;
a body base configured to be disposed in a rear of the front cover and in which the PC board and the cooling fan are installed; and
a rear cover configured to cover the body base in a rear of the body base.

5. The display device of claim 4, wherein the front cover has a fan outlet formed in a direction facing the rear surface of the display module.

6. The display device of claim 5, wherein the cooling fan is disposed to face the fan outlet.

7. The display device of claim 2, wherein the at least one antenna module is disposed between the display module and the stand base.

8. The display device of claim 2, wherein the antenna module is provided in plurality.

9. The display device of claim 8, wherein the plurality of antenna modules include:
a main antenna module configured to be disposed at a position under the stand body; and
an auxiliary antenna module configured to be disposed apart from the main antenna module in a predetermined distance.

10. The display device of claim 9, wherein the main antenna module includes a Wi-Fi module and the auxiliary antenna module includes a Bluetooth module.

11. The display device of claim 1, wherein the stand base is detachably connected to the stand body.

12. The display device of claim 1, further comprising a hinge unit configured to connect the display module and the stand each other and to control an angle of the display module,
wherein the stand completely covers the hinge unit in the rear of the display module.

13. The display device of claim 12, wherein the hinge unit includes:
a first hinge frame configured to be installed in the rear of the display module;
a second hinge frame configured to be hingedly connected to the first hinge frame and to be installed inside the stand; and
at least one hinge shaft configured to pass through the first and second hinge frames.

14. The display device of claim 13, wherein the hinge shaft is provided in a pair,
wherein the hinge unit further includes an elastic member mounted in any one hinge shaft of the pair of hinge shafts.

15. The display device of claim 13, wherein the second hinge frame includes:
a base portion configured to be extended in a horizontal direction of the stand;
at least one shaft mounting portion configured to be bent from an end of the base portion and in which the at least one hinge shaft is installed; and
a support configured to be extended downwards from the base portion and to be supported to the stand.

16. The display device of claim 15, wherein the hinge shaft is provided in a pair,
wherein the shaft mounting portion includes:
a first mounting portion configured to be bent upwards from one end of the base portion; and
a second mounting portion configured to be bent upwards from the other end of the base portion.

17. The display device of claim 15, wherein the PC unit is connected to the display module through a cable,
wherein the cable is connected to the display module by passing through the first hinge frame at an upper side of the base portion.

18. The display device of claim 13, wherein the stand includes:
a stand body configured to be installed in the rear of the display module and to have the PC unit embedded therein; and
a stand base configured to be connected to the stand body,
wherein the second hinge frame and the at least one hinge shaft are embedded in the stand body.

19. The display device of claim 18, wherein the stand body includes:
a front cover configured to be disposed in the rear of the display module;
a body base configured to be disposed in the rear of the front cover and to have the PC unit mounted therein; and
a rear cover configured to cover the body base in the rear of the body base,
wherein the second hinge frame is mounted in the body base,
wherein the rear cover completely covers the hinge unit.

20. The display device of claim 1, wherein the display device is an all-in-one computer.
